(19) United States
(12) Patent Application Publication
(10) Pub. No.: US 2025/0277489 A1
(43) Pub. Date: Sep. 4, 2025

(54) POSITIVE-DISPLACEMENT MACHINE ACCORDING TO THE SPIRAL PRINCIPLE

(71) Applicant: OET GMBH, Lustenau (AT)

(72) Inventor: Christian BUSCH, Feldkirch (AT)

(21) Appl. No.: 18/862,737

(22) PCT Filed: Apr. 11, 2023
(86) PCT No.: PCT/EP2023/059414

§ 371 Date: Nov. 4, 2024

(30) Foreign Application Priority Data
May 6, 2022 (DE) 10 2022 111 377.9

(51) Int. Cl. F04C 18/02

(52) U.S. Cl. CPC F04C 18/0207; F04C 2240/30; F04C 2240/50

(57) ABSTRACT

The invention relates to a positive-displacement machine according to the spiral principle, in particular a scroll compressor, said displacement machine comprising a housing which has a compressor housing and a drive housing, an orbiting displacement spiral and a counter spiral being located in the compressor housing and engaging into one another in such a way that variable compression chambers are formed between the displacement spiral and the counter spiral in order to receive and compress a working medium flowing through a working medium circuit, a drive shaft being located in the drive housing and being drivingly connected to the displacement spiral, a bearing plate being located between the drive housing and the compressor housing and carrying a bearing for the drive shaft, and an anti-rotation mechanism being provided between the bearing plate and the orbiting displacement spiral. The bearing plate is located completely inside the housing, the bearing plate and the bearing being made of materials having coefficients of thermal expansion which differ from one another by at most 20%, in particular by at most 10%, in particular by at most 5%.

### CROSS-REFERENCE TO RELATED APPLICATIONS

This application is a National Stage Application of International Application No. PCT/EP2023/059414, filed on Apr. 11, 2023, which claims benefit of priority to German Patent Application No. 10 2022 111 377.9, filed on May 6, 2022 which applications are incorporated herein by reference in their entirety. To the extent appropriate, a claim of priority is made to each of the above disclosed applications.

### TECHNICAL FIELD

The invention relates to a positive-displacement machine according to the spiral principle. Such a positive-displacement machine is known, for example, from DE 10 2016 118 525 B4.

The above-mentioned DE 10 2016 118 525 B4 describes a positive-displacement machine according to the spiral principle, in particular said displacement machine, comprising a scroll compressor with a housing that is made of aluminium for reasons of corrosion protection. The housing forms a wall that separates a drive chamber of the scroll compressor from a compression chamber. The wall carries a drive bearing that supports a drive shaft. The drive shaft eccentrically engages into an orbiting displacement spiral, which, in turn, is spirally engaged with a counter spiral. An orbiting movement of the displacement spiral, which is initiated by the eccentric connection with the drive shaft, creates variable compression chambers between the displacement spiral and the counter spiral, which can be used to compress a working medium.

The well-known spiral compressor also comprises an anti-rotation mechanism. The anti-rotation mechanism comprises a pin that engages an opening in the bottom of the displacement spiral, thereby preventing the displacement spiral from rotating. In this way, the displacement spiral is thrust into the desired orbital motion.

DE 10 2016 118 525 B4 has recognized that it is favourable if the pins of the anti-rotation mechanism are not inserted directly into the aluminium wall, but rather a sliding plate made of steel is formed between the aluminium wall and the displacement spiral. The pins of the anti-rotation mechanism are inserted into this sliding plate and engage into openings of the displacement spiral. For reasons of durability, the pins are also made of one steel.

The wall that carries the sliding plate is simultaneously a bearing plate that supports the bearing for the drive shaft. To ensure good durability, drive shaft bearings are usually made of steel.

Due to the different materials between the bearing plate and the bearing, there is different thermal expansion in the operation of the positive-displacement machine. This must be taken into account when pressing the bearing into the bearing plate and can lead to the bearing clearance being very small in partial load operation of the positive-displacement machine or to the bearing being preloaded during operation. Both have a negative effect on the service life of the bearing.

The object of the invention is to specify a positive-displacement machine according to the spiral principle, which comprises an improved service life. In particular, the bearing of the drive shaft is said to comprise an increased service life as a result of the invention.

Specifically, the invention is according to the idea of specifying a positive-displacement machine according to the spiral principle, in particular a scroll compressor, with a housing comprising a compressor housing and a drive housing. An orbiting displacement spiral and a counter spiral are located in the compressor housing, which engage into one another in such a way that variable compression chambers are formed between the displacement spiral and the counter spiral in order to receive and compress a working medium flowing through a working medium circuit. A drive shaft is located in the drive housing, which is drivingly connected to the displacement spiral, wherein a bearing plate is located between the drive housing and the compressor housing, which carries a bearing for the drive shaft. An anti-rotation mechanism is provided between the bearing plate and the orbiting displacement spiral. According to the invention, the bearing plate is located completely within the housing, the bearing plate and the bearing being made of materials whose coefficient of thermal expansion differs from one another by at most 20%, in particular by at most 10%, in particular by at most 5%.

The invention essentially makes use of two effects. On the one hand, the choice of material for the bearing plate and bearing ensures that the bearing does not tension with the bearing plate during operation so that the service life of the bearing is increased. On the other hand, the bearing plate is completely located inside the housing. As a result, a different material can be chosen for the bearing plate than for the housing. For example, the housing can be made of aluminium and offer appropriate corrosion protection. The bearing plate, on the other hand, can be made of steel and comprise sufficient strength to hold the bearing. In this respect, the invention is also according to the idea of a functional separation between the housing and the bearing plate. While in the prior art the housing and the bearing plate are often designed in one piece, the invention uses a two-part embodiment so that each component can be optimally configured for the function assigned to it.

Therefore, by forming the bearing plate and bearing from materials that comprise a similar coefficient of thermal expansion, the press fit between the bearing plate and the bearing can be well dimensioned, which has a positive effect on the service life of the bearing.

The bearing plate can be connected to the housing in a positive-locking manner. In particular, the bearing plate can be connected to the housing by a press fit, a screw connection, rivets or a pin connection.

In one embodiment, it is specifically provided that the bearing plate is fixed in a housing ring which is located between the drive housing and the compressor housing. With this variant, the focus is on good ease of maintenance. The housing itself features the drive housing, the housing ring, and the compressor housing. The housing ring is preferably connected to the bearing plate in a positive-locking manner. The material of the housing ring preferably corresponds to the materials of the drive housing and the compressor housing. The bearing plate is preferably made of another material, in particular, steel.

Specifically, in the case of a preferred embodiment, it is envisaged that the housing ring comprises a different material than the bearing plate and/or the compressor housing. The material of the housing ring is preferably corrosion-resistant, in particular aluminium.

Alternatively, the bearing plate can be fixed in the drive housing. With such a variant, a separate housing ring is dispensed with. The variety of components is reduced, which has a positive effect on the costs of production.

Another preferred embodiment provides that the bearing plate is fixed in the compressor housing.

Another alternative variant of the invention provides that the bearing plate is fixed, in particular in a positive-locking manner, connected to the counter spiral. The above-mentioned positive-locking connections can be used for all variants.

In another preferred embodiment of the invention, it is provided that the orbiting displacement spiral comprises a displacement spiral floor in which a sealing element is attached. The element sealing seals the orbiting displacement spiral to the bearing plate and thus to the drive housing. This increases the efficiency of the positive-displacement machine.

A sliding plate may also be placed between the bearing plate and the orbiting displacement spiral, in particular the displacement spiral floor. Preferably, the sliding plate is completely located inside the housing. It is particularly preferable if the sealing element seals against the sliding plate.

The sliding plate is preferably made of a material that comprises good sliding and sealing properties. This reduces friction within the positive-displacement machine and increases its efficiency. Simultaneously, which is important for applications in the field of electromobility, vibrations and noise emissions are reduced.

The invention is explained in more detail below by means of an exemplary embodiment with reference to the attached drawing. In it, the only FIGURE shows a partial cross-sectional view of a positive-displacement machine according to the invention according to a preferred exemplary embodiment.

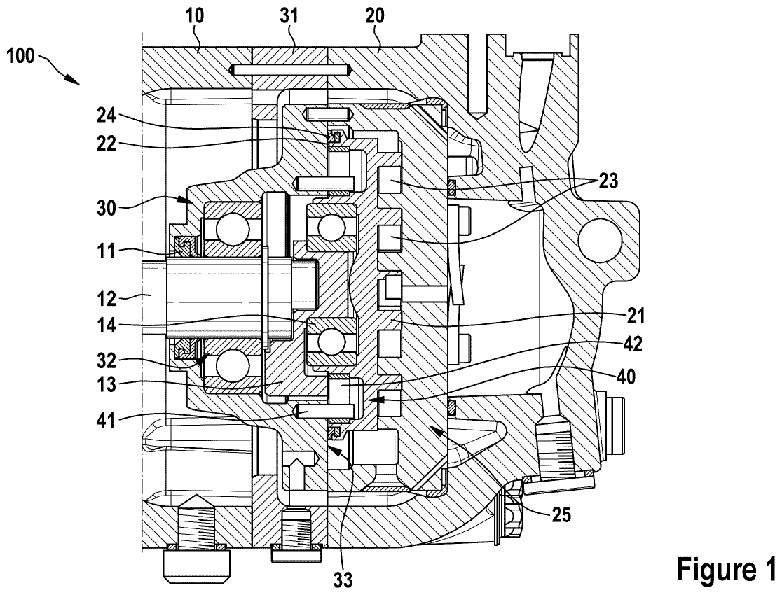

FIG. 1 shows a section of a positive-displacement machine, in particular a scroll compressor, with a housing 100. The housing 100 is divided into a drive housing 10 and a compressor housing 20. In the embodiment shown here, a housing ring 31 is located between the drive housing 10 and the compressor housing 20. The housing ring 31 is firmly connected to the drive housing 10 and the compressor housing 20. Preferably, the drive housing 10, the compressor housing 20 and the housing ring 31 are made of aluminium alloy.

In the drive housing 10 there is also a drive shaft 12. Drive housing 10 can also comprise an electric motor, which is not shown here, which directly drives the drive shaft 12.

The drive shaft 12 penetrates a bearing plate 30 and is supported within the bearing plate 30 in a bearing 32. Bearing 32 is preferably fixed in bearing plate 30 with a press fit. Upstream of bearing 32 is a shaft seal 11, which encloses the drive shaft 12 and thus closes the drive housing 10 tightly opposite the bearing plate 30.

The drive shaft 12 engages with an eccentric bearing 14 via a compensating mechanism 13. The eccentric bearing 14 is engaged with an orbiting displacement spiral 21, so that drive energy can be transferred to the orbiting displacement spiral 21 via the drive shaft 12 and the eccentric bearing 14.

In the case of the positive-displacement machine in accordance with the FIGURE, an anti-rotation mechanism 40 is also provided. The anti-rotation mechanism 40 comprises a pin 41 firmly fixed in the bearing plate 30. The pin 41 engages with play in a ring 42, which is located in an opening of the displacement spiral 21. Through the play between the ring 42 and the pin 41, the displacement spiral 21 is forced into orbiting motion by the eccentricity on the drive shaft 12. A simple rotation of the displacement spiral is thereby prevented.

In order to ensure a good seal between the orbiting displacement spiral 21 and the bearing plate 30, the bearing plate 30 also carries a sliding plate 33. The orbiting displacement spiral 21 also comprises a sealing element 24, which is pressed against the sliding plate 33 and thus ensures good tightness. The sealing element 24 can be a circumferential O-ring.

As can also be clearly seen in the FIGURE, the bearing plate 30 is located completely inside the housing. The bearing plate 30 is firmly connected to the counter spiral 25. In particular, the connection can be established in a positive-locking manner. For example, mounting pins inserted with a press fit can hold the bearing plate 30 to the counter spiral 25. Alternatively, a screw connection, riveting or a tolerance ring design is also possible.

The bearing plate 30 can be made of a steel or a cast material. Preferably, a material is used that is also used for the production of the shaft bearing 32. In any case, the bearing plate 30 and the shaft bearing 32 shall be made of materials which comprise the same or at least similar coefficients of thermal expansion. In the operation of the positive-displacement machine, the shaft bearing 32 and the bearing plate 30 expand evenly. The press fit between the shaft bearing 32 and the bearing plate 30 can thus be dimensioned well and precisely, which has a positive effect on the service life of the shaft bearing 32.

### REFERENCE LIST

10 drive housing
11 shaft seal
12 drive shaft
13 balancing mechanism
14 eccentric bearing
20 compressor housing
21 orbiting displacement spiral
22 displacement spiral floor
23 compression chamber
24 sealing element
25 counter spiral
30 bearing plate
31 housing ring
32 bearing
33 sliding plate
40 anti-rotation mechanism
41 pin
42 ring
100 housing

1. A positive-displacement machine according to the spiral principle, in particular scroll compressors, comprising a housing comprising a compressor housing and a drive housing, wherein an orbiting displacement spiral and a counter spiral are located in the compressor housing, which engage into one another in such a way that variable compression chambers are formed between the positive-displacement spiral and the counter spiral in order to receive and compress a working medium flowing through a working medium circuit, wherein, in the drive housing, a drive shaft is located, which is drivingly connected to the displacement spiral, wherein, a bearing plate is located between the drive housing and the compressor housing, which bearing plate carries a bearing for the drive shaft, and wherein an anti-rotation mechanism is provided between the bearing plate and the orbiting positive-displacement spiral, wherein the bearing plate is located entirely within the housing, wherein the bearing plate and the bearing are made of materials whose coefficient of thermal expansion differs by at most 20%, in particular by at most 10%, in particular by at most 5%.

2. The positive-displacement machine according to claim 1, wherein the bearing plate is connected to the housing in a positive-locking manner.

3. The positive-displacement machine according to claim 1, wherein the bearing plate is fixed in a housing ring which is located between the drive housing and the compressor housing.

4. The positive-displacement machine according to claim 3, wherein the housing ring comprises a material other than the bearing plate, in particular the same material as the drive housing and/or the compressor housing.

5. The positive-displacement machine according to claim 1, wherein the bearing plate is fixed in the drive housing.

6. The positive-displacement machine according to claim 1, wherein the bearing plate is fixed in the compressor housing.

7. The positive-displacement machine according to claim 1, wherein the bearing plate is firmly connected to the counter spiral, in particular in a positive-locking manner.

8. The positive-displacement machine according to claim 1, wherein the orbiting displacement spiral comprises a displacement spiral floor in which a sealing element is attached.

9. The positive-displacement machine according to claim 1, wherein a sliding plate is located between the bearing plate and the orbiting displacement spiral, in particular the displacement spiral floor.

10. The positive-displacement machine according to claim 9, wherein the sliding plate is located completely within the housing.

11. The positive-displacement machine according to claim 9, wherein the sealing element seals against the sliding plate.
